(19) United States
(12) Patent Application Publication
(10) Pub. No.: US 2025/0110721 A1
(43) Pub. Date: Apr. 3, 2025

(54) OPERATING SYSTEM LIFECYCLE MANAGEMENT USING MACHINE LEARNING

(71) Applicant: Teachers Insurance and Annuity Association of America, New York, NY (US)

(72) Inventor: Sagar Madhok, Mumbai (IN)

(21) Appl. No.: 18/374,913

(22) Filed: Sep. 29, 2023

(51) Int. Cl. G06F 8/65; G06F 9/4401

(52) U.S. Cl. CPC G06F 8/65; G06F 9/4406

(57) ABSTRACT

A system includes a memory, and a processing device, operatively coupled to the memory, to perform operations including obtaining, by at least one processing device, input data comprising a set of parameters associated with a computing environment, determining, by the at least one processing device using a machine learning (ML) model based on the input data, whether a device of the computing environment is due for an operating system (OS) upgrade, and in response to determining that the device is due for the OS upgrade, initiating, by the at least one processing device, the OS upgrade for the device.

### TECHNICAL FIELD

Implementations of the disclosure relate generally to database management, and more specifically, relate to operating system (OS) lifecycle management using machine learning (ML).

### BACKGROUND

An enterprise network can include multiple devices communicably coupled by a private network owned and/or controlled by an enterprise (e.g., organization). An enterprise network can include an on-premises subnetwork in which software is installed and executed on computers on the premises of the enterprise using the software.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 illustrates an example computer system for implementing operating system (OS) lifecycle management using machine learning (ML), in accordance with some implementations of the present disclosure.

FIGS. 2-6 are flow diagrams of example methods to implementing operating system (OS) lifecycle management using machine learning (ML), in accordance with some implementations of the present disclosure.

FIG. 7 is a block diagram of an example computer system in which implementations of the present disclosure may operate.

### DETAILED DESCRIPTION

Aspects of the present disclosure are directed to implementing operating system (OS) lifecycle management using machine learning (ML). A computing environment can include multiple devices communicatively coupled via a network. The network can include one or more of: a local area network (LAN) to connect devices within a limited region (e.g., a building), a wide area network (WAN) to connect devices across multiple regions (e.g., using multiple LANs), etc. An enterprise network can include multiple devices communicably coupled by a private network owned and/or controlled by an enterprise (e.g., organization). An enterprise network can include an on-premises subnetwork in which software is installed and executed on computers on the premises of the enterprise using the software. Additionally or alternatively, an enterprise network can include a remote subnetwork (e.g., cloud subnetwork) in which software is installed and executed on remote devices (e.g., server farm). An enterprise network can be used to facilitate access to data and/or data analytics among devices of the private network. Examples of devices of an enterprise network can include client devices (e.g., user workstations), servers (e.g., web servers, email servers, high performance computing (HPC) servers, database servers and/or virtual private network (VPN) servers), etc. An information technology (IT) infrastructure can be used to provide IT services for the computing environment. The IT infrastructure can be deployed locally within the enterprise, or using a remote system (e.g., cloud infrastructure). Components of an IT infrastructure can include hardware components and software components. Hardware and/or software components can include processing components, storage components, network components, etc. Hardware components can include one or more of: servers, client devices, routers, switches, load balancers, network security devices (e.g., firewall devices), etc. Software components can include applications used by the enterprise, such as operating systems (OS), web servers, content management databases (CMDBs), etc.

Components of a computing environment can be monitored to perform one or more types of management tasks to ensure proper functioning of the computing environment. One type of management task is OS lifecycle management. OS lifecycle management can encompass various aspects of installing an OS, upgrading an OS (e.g., patching), managing OS subscriptions, etc. An OS can require frequent upgrades (e.g., patches), which can be important to mitigate security vulnerabilities and enhance feature sets. OS upgrades for each device type can operate in accordance with a particular sequence of OS upgrade steps (“OS upgrade playbook”). Therefore, OS lifecycle management across multiple device types using manual approaches can increase the probability of OS upgrade errors.

Additionally, some OS upgrades can adversely affect the performance of a computing environment, such as abnormally high resource consumption. It may not be possible for a system administrator to effectively analyze the effect that an OS upgrade for a single device might have on a computing environment, let alone the effect that multiple OS upgrades for multiple devices might have on the computing environment. In other words, it may be not possible to predict whether OS upgrades for one or more devices within a computing environment will have negative impacts on the computing environment. For example, assume that an event involving a large number of OS upgrades for multiple types of devices of a computing environment from a previous OS version to an updated OS version (e.g., mass OS migration event) has occurred. A system administrator may determine, after the event, that the OS upgrades have resulted in a negative impact on the computing environment (e.g., abnormally high resource consumption significantly impacting performance). The system administrator may have to go through the laborious task of rolling back OS upgrades to previous OS versions.

Aspects of the present disclosure address the above and other deficiencies by enabling OS lifecycle management using ML. OS lifecycle management described herein can be performed for various types of devices used within a computing environment. In some implementations, the computing environment includes an enterprise network. Examples of devices include servers, client devices, routers, switches, load balancers, network security devices (e.g., firewall devices), etc.

Implementations described herein can enable automation of the entire lifecycle of an OS, including deploying the OS for a device, using ML models to analyze OS parameters during day-to-day usage of the device, and managing OS upgrades for devices within a computing environment. More specifically, an OS lifecycle management system can include an OS monitoring system that can use a set of ML models to analyze the OS parameters of a set of devices within the computing environment, and an OS deployment system that can manage OS upgrades and OS deployment for the set of devices. For example, the OS monitoring system can determine whether an OS for a device should be upgraded, and the OS deployment system can manage an OS process for the device if the OS monitoring system has determined that the OS for the device should be upgraded. In some implementations, the OS monitoring system sets an upgrade flag in response to determining that the OS for the type of device should be upgraded. For example, the upgrade flag can be a bit flag. The OS deployment system can detect the upgrade flag and initiate an OS upgrade process for the OS for the type of device in response to detecting the upgrade flag. The upgrade flag can be reset by the OS deployment system after the OS upgrade is complete. Further details regarding the upgrade flag will be described herein below.

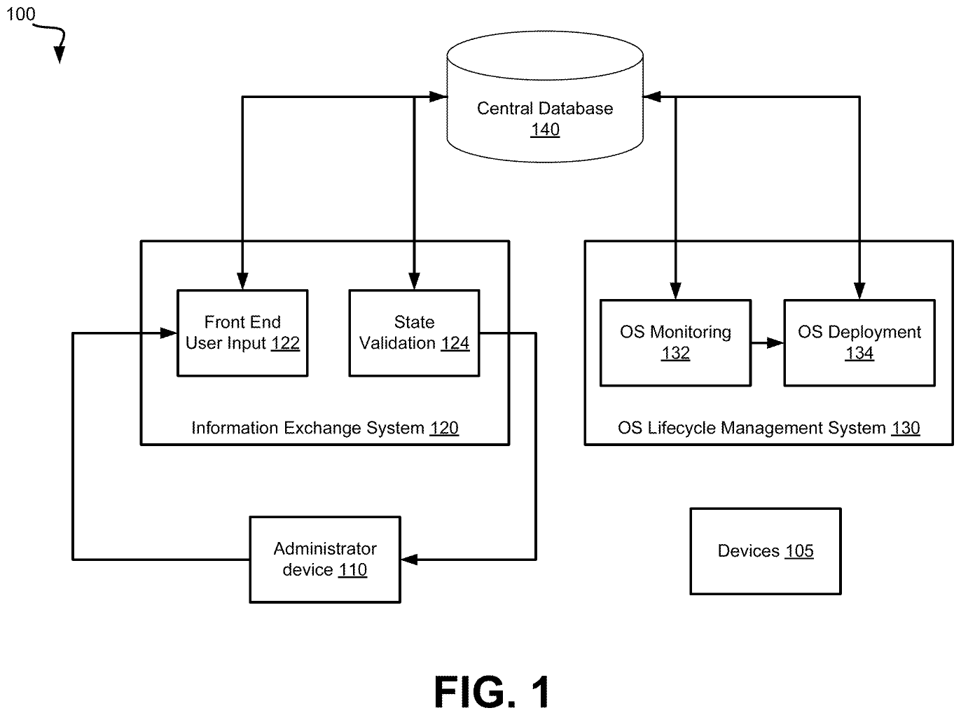

The OS upgrade process is an ML-driven automated process that can, after determining that an OS upgrade for a type of device can be performed (e.g., if the upgrade flag has been set), manage the OS upgrade for the type. For example, as will be described in further detail below, the OS upgrade process can include, for each type of device, a customized set of processes that can be used to automatically manage the OS upgrade. A customized set of processes for a type of device can be referred to as an “OS upgrade playbook” for the device. Examples of processes of the customized set of processes can include OS staging, precheck and post-check processes (e.g., an OS upgrade playbook for the type of device). Further details regarding enabling OS lifecycle management using ML will be described in further detail below with reference to FIGS. 1-6.

Advantages of the present disclosure include, but are not limited to, improved computer system performance and QoS. For example, implementations described herein can be technology agnostic. Implementations described herein can provide a zero-touch or near-zero-touch (i.e., fully automated or nearly-fully automated) ML model to drive end-to-end OS life cycle management. Implementations described herein can provide for a highly flexible and scalable OS lifecycle management solution.

FIG. 1 illustrates an example computing environment 100 for implementing OS lifecycle management using ML, in accordance with some implementations of the present disclosure. Computing environment 100 can include devices 105, at least one administrator device 110 operable by at least one system administrator, information exchange system 120 communicably coupled to administrator device 110 and including front end user interface component 112 and state validation component 124, OS lifecycle management system 130, and central database 140 communicably coupled the information exchange system 120.

Devices 105 can include hardware components and/or software components. For example, devices 105 can include one or more of: at least one client device, at least one server, at least one router, at least one switch, at least one load balancer, at least one network security device (e.g., firewall device), etc. Examples of client devices include at least one of a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), etc.

Administrator device 110 can be a computing device including a memory and a processing device operatively coupled to the memory. Examples of computing devices include at least one of a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), etc.

Front end user interface component 122 can implement a user interface (UI) (e.g., graphical user interface (GUI)) that can enable information related to managing the lifecycle of an OS of at least one device of computing environment 100 to be displayed on a user device, such as administrator device 100, and can enable the user device to control OS upgrades based on the information. For example, information related to managing the lifecycle of the OS can include information regarding managing OS upgrades (e.g., patching). Information regarding managing OS upgrades can include OS history and next available OS. State validation component 124 can present (and download) the current state of the OS across computing environment 100. For example, the current state of the OS can indicate a status of the version of the OS.

Central database 140 can store and update information from IT infrastructure devices and can be queried on an as-needed basis. For example, central database 140 can store information related to an OS upgrade of a device of computing environment 100. As another example, central database 140 can maintain data indicating which devices of computing environment 100 have had a recent OS upgrades and which devices of computing environment 100 have not yet had a recent OS upgrade. For example, central database 140 can maintain data indicating which switches of computing environment 100 have had a recent OS upgrade and which switches of computing environment 100 have not yet had a recent OS upgrade.

OS lifecycle management system 130 can manage OS lifecycles devices 105. For example, OS lifecycle management system 130 can include OS monitoring component 132. OS monitoring component 132 can monitor activity of at least one device of computing environment 100 to obtain a set of OS parameters, and store the set of OS parameters within central database 140. Obtaining the set of OS parameters can include executing a set of commands on a set time interval to generate the set of OS parameters. The OS parameters can then stored in a location within central database 140. The set of parameters can include parameters related to a status of the device within computing environment, such as resource utilization parameters (e.g., processing, storage and/or network utilization parameters), environmental status parameters, time synchronization parameters, OS version parameters, etc. The set of OS parameters can be obtained by issuing a set of commands to retrieve data for a type of device, and receiving a set of data in response to issuing the set of commands.

To illustrate, assume that a device is a network infrastructure element, such as switch. The set of commands for a switch can include “show version”. The show version command causes information about the switches' hardware and software versions to be displayed, including the OS, firmware, and any installed modules or licenses. The set of commands for a switch can further include “show environment”. The show environment command can cause information about the environmental status of the switch to be displayed, such as temperature, power supply status, and fan speed. The set of commands for a switch can further include “show neighboring devices”. The show neighboring devices command can cause a list of devices connected to the switch to be displayed. The set of commands can further include “show time synchronization status”. The show time synchronization status command can cause an indication of whether the switch is time synchronized with a server and the accuracy of the time synchronization (e.g., using Network Time Protocol (NTP)). The set of commands can further include “show tech-support”. The show tech-support command can cause troubleshooting data to be displayed, such as a comprehensive output of the switch's configuration, status, and other relevant information. The set of commands can further include “show mac address-table”. The show mac address-table command can cause a listing of MAC addresses learned by the switch to be displayed, along with associated ports and other relevant data. The set of commands can further include “show spanning tree summary”. The show spanning tree summary can cause a Spanning Tree Protocol (STP) status to be displayed. The set of commands can further include a “show processes cpu” command. The show processes cpu command can cause CPU utilizations statistics to be displayed, which can indicate CPU resources being used by various processes by the switch. The set of commands can further include a “show memory summary” command. The show memory summary command can cause an overview of the switch's memory usage to be displayed, including the amount of free, used, and total memory, as well as memory allocation details.

OS monitoring component 132 can analyze a set of OS parameters for a device to perform at least one action related to managing the OS of the device. More specifically, OS monitoring component 132 can use one or more ML models trained to make one or more predictions based on the set of OS parameters, such as service status, trend analysis, fault prediction, etc. OS monitoring component 132 can be customized to learn the pattern and/or behavior of the one or more devices with respect to device type and/or OS type. For example, OS monitoring component 132 can use multiple ML models, where each ML model is trained using information related to a particular type of device within computing environment 100.

For example, a ML model can be a supervised learning model trained to make predictions using supervised learning. In some implementations, a ML model is a regression model. A supervised learning method utilizes labeled training datasets to train a ML model to make predictions. More specifically, a supervised learning method can be provided with input data (e.g., features) and corresponding output data (e.g., target data), and the ML model learns to map the input data to the output data based on the examples in the labeled dataset. For example, to train a ML model to perform a classification, the input data can include various attributes of an object or event, and the output data may be a class (e.g., label or category). The labeled dataset would contain examples of these objects or events along with their corresponding labels. The ML model can be trained to map the input data to the correct class by analyzing the examples in the labeled dataset. Correct predictions made by a ML model can be rewarded, which can improve the performance of the ML model.

OS monitoring component 132 can analyze the set of parameters using one or more ML models to perform OS lifecycle management. For example, OS monitoring component 132 can perform OS lifecycle managing by determining whether to trigger an OS upgrade for a type of device, and trigger the OS upgrade for the type of device in response to determining to trigger the OS upgrade for the type of device. Triggering the OS upgrade for the type of device can include OS monitoring component 132 setting an upgrade flag indicating whether a type a device is due for an OS upgrade. For example, the upgrade flag can be a bit flag. As will be described in further detail below, OS deployment 134 of OS lifecycle management system 130 can determine whether to initiate an OS upgrade process for a type of device based on the update flag. In some implementations, an upgrade flag includes data indicating that a type of device is due for an OS upgrade. For example, if the upgrade flag is not set, then the OS is not due for an OS upgrade (e.g., the upgrade flag is cleared after a latest OS upgrade is complete). As another example, if the upgrade flag is set, this means that the OS is due for an OS upgrade (e.g., the upgrade flag can be set some amount of time since the last OS upgrade). In some implementations, an upgrade flag includes data indicating that a type of device is not due for an OS upgrade. For example, if the upgrade flag is not set, then the OS is due for an OS upgrade (e.g., the upgrade flag is cleared some time since the last OS upgrade). As another example, if the upgrade flag is set, this means that the OS is not due for an OS upgrade (e.g., the upgrade flag can be set after a latest OS upgrade is complete).

As another example, OS monitoring component 132 can perform OS lifecycle managing by performing anomaly detection. More specifically, OS monitoring component 132 can use one or more ML models trained to make predictions related to anomaly detection, such as service status, trend analysis, fault prediction, etc. OS monitoring component 132 can be customized to learn the pattern and/or behavior of the one or more devices with respect to device type and/or OS type. Illustratively, a ML model for predicting anomalies in CPU utilization can be provided with a dataset related to CPU utilization for training the ML model. For example, the dataset can include various ranges of CPU utilization, with each range of CPU utilization corresponding to a level of anomaly. To illustrate, if the CPU utilization is between 0-20%, then the ML model can be trained to provide an indication that the CPU utilization is not anomalous (e.g., green colored indicator). If the CPU utilization is between 21-65%, then the ML model can be trained to provide an indication that the CPU utilization may be anomalous (e.g., amber colored indicator). If the CPU utilization is between 66-90%, then the ML model can be trained to provide an indication that the CPU utilization is more than likely anomalous (e.g., red colored indicator). If the CPU utilization is between 91-100%, then the ML model can be trained to provide an indication that the CPU utilization is abnormally high and should be addressed (e.g., a panic label).

The anomaly detection can be used to determine whether to halt an OS upgrade for a type of device. For example, if OS monitoring component 132 detects an anomaly after an OS upgrade has been completed for a device, then OS monitoring component 132 can cause the OS upgrade for other devices of a similar type to be halted. Causing OS upgrades for the at least one device to be halted can include resetting an upgrade flag for the at least one device. Illustratively, assume that devices 105 include ten switches. Of the ten switches, four have undergone an OS upgrade. OS monitoring component 132 can use anomaly detection to determine whether to halt OS upgrades for the remaining six switches. The halting of the OS upgrade can allow for further analysis of computing environment 100 to determine why the OS upgrade has led to the detected anomalous behavior. In some implementations, halting an OS upgrade includes rolling back at least some changes made during the OS upgrade.

OS deployment component 134 can manage deployment of OS upgrades for devices 105. Managing deployment of an OS upgrade for a type of device can include determining whether an OS of the type of device is due for an OS upgrade. In some implementations, determining whether the OS of the type of device is due for an OS upgrade is performed by determining an upgrade status of the device. For example, the upgrade status of the device can be determined by analyzing the upgrade flag, which can be set by OS monitoring component 132 as described above.

If it is determined that the OS of the type of device is due for an upgrade, then OS deployment component 134 can initiate an OS upgrade for the device. Performing the OS upgrade can include selecting an OS that is approved for the device, and initiating a staging of the OS. An approved OS is an OS that is compatible with the device. For example, an approved OS can satisfy a variety of compatibility and/or security requirements for the computing environment (e.g., enterprise network) to reduce the risk of security breaches or other vulnerabilities that may be associated with using an unapproved OS. Staging the OS refers to testing the OS within a staging environment before deployment (e.g., before upgrading the device). The staging environment is a test execution environment that is separate from and mimics an actual execution environment (e.g., production environment).

Managing the OS upgrade can further include determining whether to continue the OS upgrade using the staged OS. In some implementations, determining whether to continue the OS upgrade using the staged OS can include executing a precheck process using the staged OS to check if any issues (e.g., “red flags”) exist prior to continuing the OS upgrade. A precheck process can include one or more customized sub-processes that are customized for a type of device, which can be used to determine whether any issues exist with respect to the type of device. For example, OS deployment component 134 can select a precheck process for a type of device, and automatically execute the precheck process for the type of device without additional user interaction.

Executing the precheck process can include analyzing a set of parameters associated with the device. The set of parameters can be maintained within central database 140. Examples of parameters of the set of parameters include processing resource utilization, change in the utilization based on time (e.g., particular time of day, week, month), frequency of system log generation (e.g., during a day), utilization trend of memory resources, number of free processing unit cycles, responsiveness of the device (e.g., how quickly the device returns the output of a command), etc. For example, the set of parameters can include a set of performance parameters. The set of parameters can include a set of environmental parameters, which can include parameters related to processing resources (e.g., central processing units (CPUs)), memory resources, temperature, cooling resources (e.g., fans), power supply, etc. The set of parameters can further include information regarding utilization of interfaces. The set of parameters can further include information regarding the current version of the OS installed on the device, such as current OS version details and a path to where the OS is maintained. The set of parameters can further include a backup of the running configuration. The set of parameters can further include a set of network parameters. Examples of network parameters include connected devices, routing parameters, switching parameters, address resolution protocol (ARP) tables maintained by switches that store internet protocol (IP) addresses and media access control (MAC) addresses of devices within the enterprise network, MAC address tables maintained by switches that store information regarding interfaces (e.g., Ethernet interfaces) to which the switches are connected to within the enterprise network, etc. The set of parameters can further include a backup of system logs. The set of parameters can further include a connectivity check. In some implementations, determining whether to continue the OS upgrade further includes receiving an indication that the OS upgrade is approved (e.g., after the precheck process determines that the OS upgrade can continue).

In some implementations, determining whether the OS upgrade should continue includes using one or more ML models trained to predict, based on the set of parameters, whether an issue with implementing the OS upgrade exists. For example, an issue can be a deviation from normal device activity (e.g., excessively high resource consumption). For example, a ML model for a device can receive the set of parameters and apply thresholds to the set of parameters to determine a deviation from normal device activity. A ML model can be trained for each type of device of devices 105 to enable more granular OS upgrade control on a per-device basis. Other examples of issues can include OS upgrade errors, OS upgrade compatibility issues, etc.

If it is determined that the OS upgrade should continue (e.g., the precheck process has not uncovered any issues with implementing the OS upgrade and/or an indication that the OS upgrade is approved has been received), OS deployment component 134 can cause the OS upgrade to be completed. Completing the OS upgrade can include loading (e.g., reloading) the upgraded OS. In some implementations, completing the OS upgrade further includes executing a post-check process to confirm that there are no issues with implementing the upgraded OS. A post-check process can be similar to the precheck process. More specifically, a post-check process can include a customized set of post-check processes for the type of device that can be used to determine whether any issues exist with respect to the type of device after loading the upgraded OS. For example, OS deployment component 134 can select a customized set of post-check processes for the type of device, and automatically execute the customized set of post-check processes for the type of device without additional user interaction. Completing the OS upgrade can further include updating an upgrade status of the type of device (e.g., updating the corresponding upgrade flag).

OS lifecycle management system 130 can be used to improve the performance of computing environment 100. For example, assume that an event involving a large number of OS upgrades for multiple types of devices of a computing environment from a previous OS version to an updated OS version (e.g., mass OS migration event) has occurred. OS upgrade management system 130, can determine, after the event, that the OS upgrades have resulted in a negative impact on performance of computing environment 100 (e.g., abnormally high resource consumption that significantly impacts performance). OS lifecycle management system 130 can manage the OS upgrades to improve performance of computing environment 100.

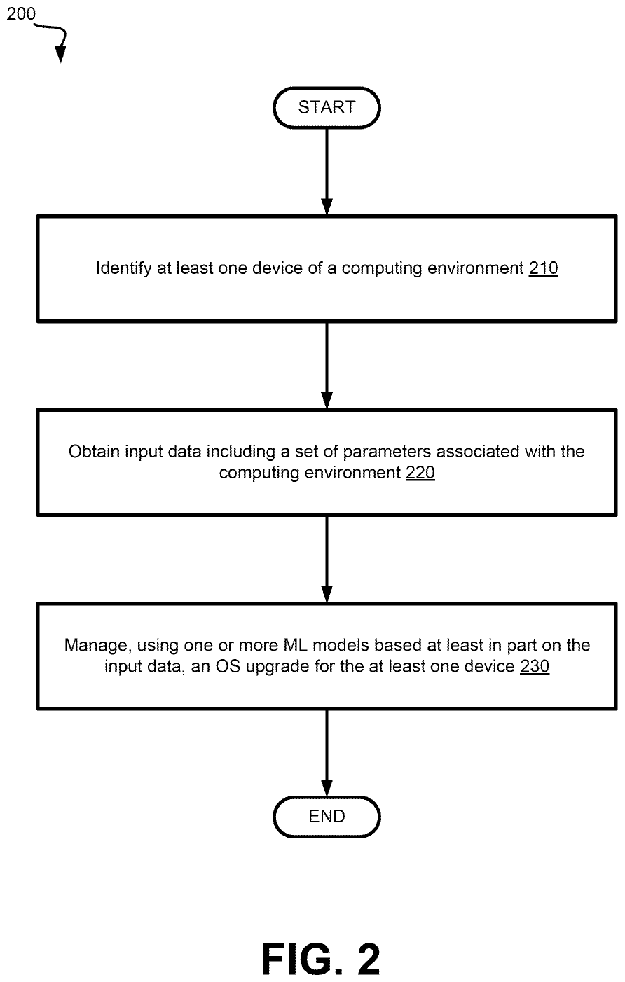

ML models of OS lifecycle management system 130 can also be trained and use for forecasting purposes. For example, a ML model can be trained to learn that it is atypical for a type of device to undergo an OS upgrade at a particular frequency, or fail to undergo an OS upgrade after a certain amount of time, by detecting a deviation from an OS upgrade history for the type of device. Illustratively, if a device has historically had an OS upgrade once every 3 months, but it has not had an upgrade in over 3 months, then a ML model can identify the deviation from the OS upgrade history for the device. OS upgrade management system 130 can then cause an indication of the deviation to be generated (e.g., an alert or message). Additionally, OS lifecycle management system 130 can determine whether at least one device has a different OS version than at least one other device of the same type, which can be used to generate a recommendation to upgrade the OS of at least one device of the type to maintain OS consistency across devices of the same type. This recommendation can function as a trigger to control OS upgrades among the device (e.g., control the upgrade flag setting). Further details regarding operations of OS lifecycle managing system 130 will now be described in further detail below with reference to FIGS. 2-6.

FIG. 2 is a flow diagram of an example method 200 to implement OS lifecycle management using ML, in accordance with some implementations of the present disclosure. Method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 200 is performed by one or more components of computing environment 100 of FIG. 1, such as OS upgrade management system 130. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 210, processing logic identifies at least one device of a computing environment. A device can have an associated OS. For example, the at least one device can include one or more of: at least one client device, at least one server, at least one router, at least one switch, at least one load balancer, at least one network security device (e.g., firewall device), etc. Examples of client devices include desktop computers, laptop computers, network servers, mobile devices, vehicles (e.g., airplanes, drones, trains, automobiles, or other vehicles), Internet of Things (IoT) devices, embedded computers (e.g., one included in a vehicle, industrial equipment, or a networked commercial device), etc.

At operation 220, processing logic obtains input data including a set of parameters associated with the computing environment. The input data including the set of parameters can be extracted from various data sources within the computing environment, and maintained within at least one repository (e.g., database) of the computing environment. The set of parameters can include at least one of: a set of environmental parameters associated with the computing environment, information regarding utilization of interfaces, information regarding a current version of an OS installed on the device, a backup of a running configuration, a set of network parameters, a backup of system logs, or a connectivity check. The set of environmental parameters can include parameters related to at least one of processing resources (e.g., CPUs), memory resources, temperature, cooling resources (e.g., fans), power supply, etc. The set of network parameters can include parameters related to at least one connected device, routing parameters, switching parameters, ARP tables maintained by switches that store IP addresses and MAC addresses of devices within the enterprise network, MAC address tables maintained by switches that store information regarding interfaces (e.g., Ethernet interfaces) to which the switches are connected to within the enterprise network, etc.

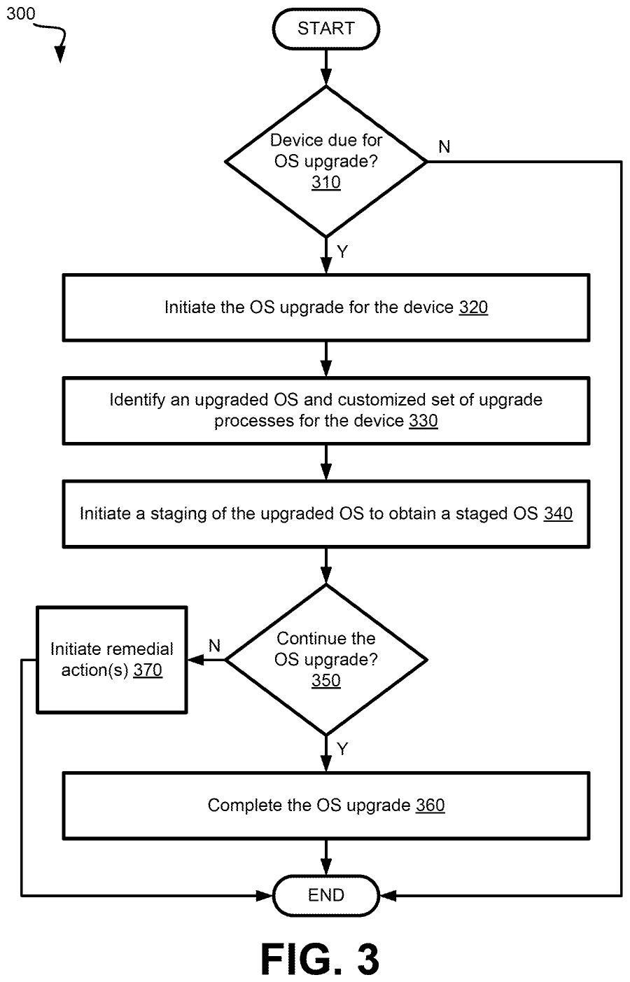

At operation 230, processing logic manages, using one or more ML models based at least in part on the input data, an OS upgrade for the at least one device. Managing the OS upgrade for the at least one device can include determining whether the at least one device is due for the OS upgrade, and initiating the OS upgrade for the device in response to determining that the device is due for the OS upgrade. Managing the OS upgrade can further include completing the OS upgrade in response to determining to complete the OS upgrade. Managing the OS upgrade can further include performing at least one remedial action in response to determining not to complete the OS upgrade. For example, performing the at least one remedial action can include at least one of canceling the OS upgrade or performing an OS downgrade (e.g., reverting the OS to a previous version). Further details regarding managing the OS upgrade for the at least one device are described above with reference to FIG. 1 and will now be described below with reference to FIGS. 3-5.

FIG. 3 is a flow diagram of an example method 300 to manage an OS upgrade for at least one device of a computing environment, in accordance with some implementations of the present disclosure. For example, method 300 can correspond to operation 230 of FIG. 2. Method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 300 is performed by one or more components of computing environment 100 of FIG. 1, such as OS upgrade management system 130. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 310, processing logic determines whether a device is due for an OS upgrade. In some implementations, determining whether the device is due for the OS upgrade further comprises determining whether an upgrade flag for the device is set. If it is determined that the device is not due for an OS upgrade (e.g., the upgrade flag for the device is set), then the process ends since an OS upgrade is not needed. If it is determined that the device is due for an OS upgrade (e.g., the upgrade flag for the device is not set), then processing logic at operation 320 initiates the OS upgrade for the device.

At operation 330, processing logic identifies an upgraded OS and a customized for the device. The upgraded OS can be identified as an approved OS, which can be selected from an approved OS list of approved OS's that are compatible with the device. For example, an approved OS can satisfy a variety of compatibility and/or security requirements for the computing environment (e.g., enterprise network) to reduce the risk of security breaches or other vulnerabilities that may be associated with using an unapproved OS. The customized set of upgrade processes for the device can control various aspects of the OS upgrade process. For example, the customized set of upgrade processes can control staging, precheck operations, post-check operations, etc., as described above with reference to FIG. 1 and as will be described in further detail herein below.

At operation 340, processing logic initiates a staging of the approved OS to obtain a staged OS. For example, the staging can be performed in accordance with the customized set of upgrade processes for the device.

At operation 350, processing logic determines whether to continue the OS upgrade using the staged OS. More specifically, the determination at operation 350 can be made based at least in part on a set of parameters associated with the computing environment. For example, the set of parameters can be similar to the set of parameters obtained at operation 210 of FIG. 2.

In some implementations, determining whether to continue the OS upgrade includes executing a precheck process using the staged OS to determine whether the upgraded OS passes the precheck process. The precheck process can be performed in accordance with the customized set of upgrade processes for the device. Further details regarding the precheck process are described above with reference to FIG. 1.

In response to determining to continue the OS upgrade (e.g., the precheck process indicates that there would not be any issues with the device having the OS upgrade), processing logic at operation 360 completes the OS upgrade. In some implementations, completing the OS upgrade includes loading the device with the upgraded OS. In some implementations, completing the OS upgrade includes executing a post-check process. The post-check process can be executed to determine whether there are any issues with the OS upgrade (e.g., finalizing the OS upgrade). For example, the post-check process can be performed in accordance with the customized set of upgrade processes for the device. If the post-check process determines that there are no issues with the OS upgrade, the OS upgrade can be finalized.

In response to determining to discontinue the OS upgrade at operation 350 (e.g., the precheck indicates that there would be issues with the device having the OS upgrade), processing logic at operation 370 can initiate at least one remedial action. For example, the at least one remedial action can be performed in accordance with the customized set of upgrade processes. In some implementations, initiating the at least one remedial action includes initiating at least one of: cancelation of the OS upgrade, postponement of the OS upgrade, or an OS downgrade (e.g., reverting an OS to a previous version). Initiating the at least one remedial action can further include halting deployment of the upgraded OS with respect to similar types of devices of the computing environment, which can improve operation of the computing environment (e.g., by reducing unnecessary resource consumption resulting from deploying the upgraded OS on other devices). In some implementations, initiating the at least one remedial action includes automatically performing the at least one remedial action. In some implementations, initiating the at least one remedial action includes generating and sending an alert or message to one or more administrator devices indicating that the OS upgrade should be discontinued.

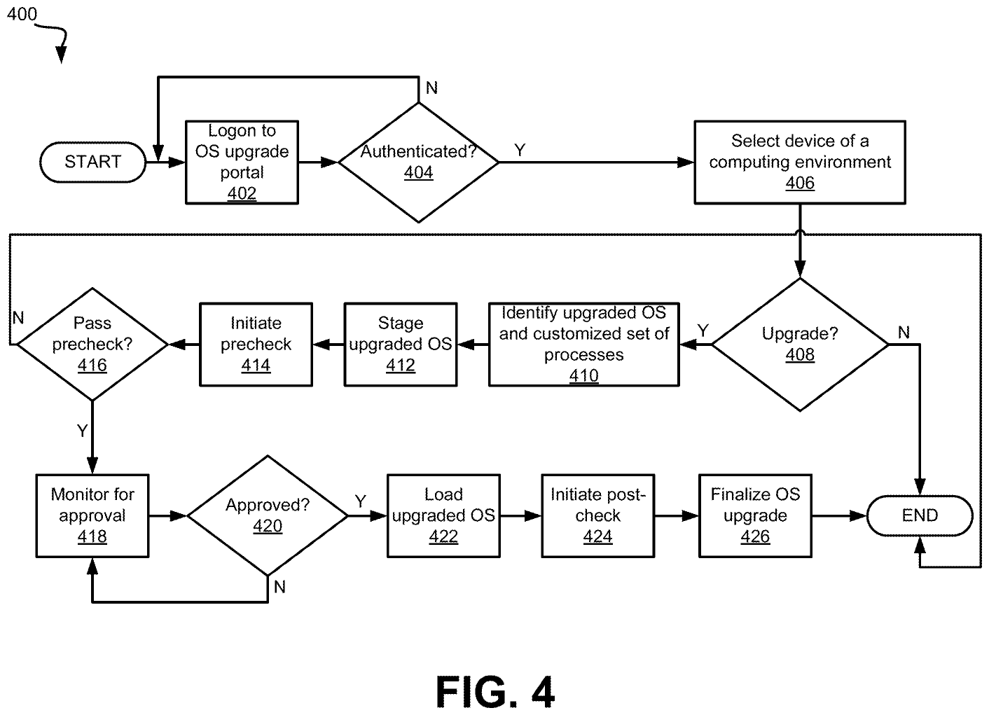

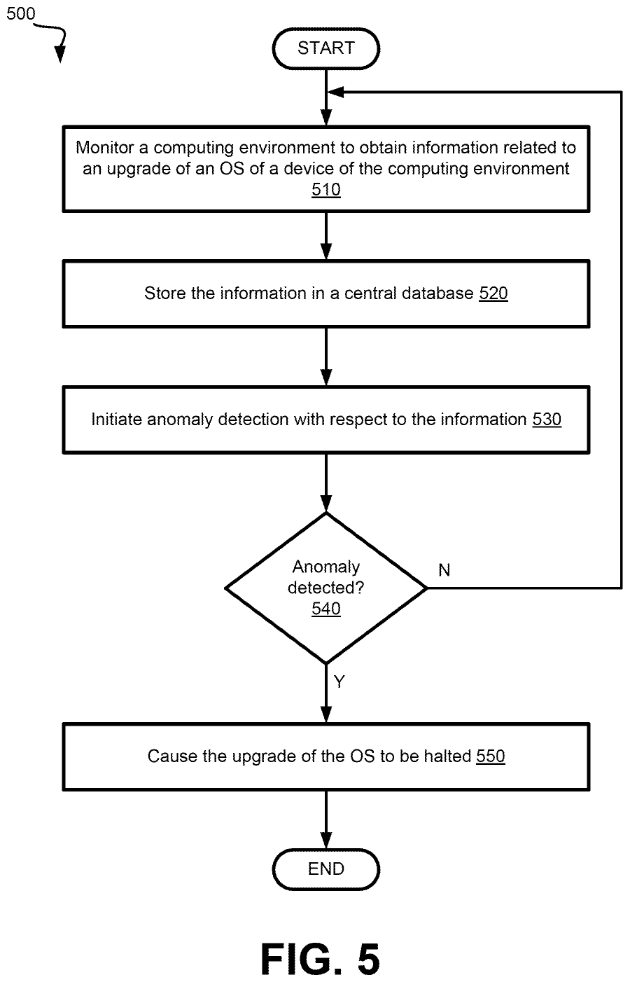

In some implementations, at least one of determining whether the OS upgrade should continue (e.g., performing the precheck process) or determining whether the OS upgrade should continue (e.g., performing the post-check process) includes using a ML model to predict whether an issue exists based on the set of parameters. A ML model can be trained to monitor a wide variety of parameters over times. For example, a ML model can be trained to accept the values of the parameters and apply thresholds to the parameters to build intelligent data gathering and subsequent reporting in case of sudden deviation from normal trend. Examples of parameters include processing resource utilization before and after OS upgrade, change in the utilization based on time (e.g., particular time of day, week, month), frequency of system log generation (e.g., during a day), utilization trend of memory resources, number of free processing unit cycles, responsiveness of the device (e.g., how quickly the device returns the output of a command), etc. For example, a ML model can be trained to make predictions by associating issues with prior sets of parameters (e.g., supervised learning) and/or using reinforcement learning. A ML model can be trained for each type of device of the computing environment to enable more granular control on a per-device basis. For example, assume that there has been a successful OS upgrade of multiple servers in a computing environment. A ML model can be used to determine a correlation between the OS upgrade and a surge in computing resource utilization (e.g., processing, storage and/or network resource utilization). Further details regarding managing the OS upgrade for the at least one device are described above with reference to FIGS. 1-2 and will now be described below with reference to FIGS. 4-5.

FIG. 4 is a flow diagram of an example method 400 to manage an OS upgrade for at least one device of a computing environment, in accordance with some implementations of the present disclosure. For example, method 400 can correspond to operations 210-230 of FIG. 2. Method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 400 is performed by one or more components of computing environment 100 of FIG. 1, such as OS upgrade management system 130. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 402, processing logic receives a logon attempt to an OS upgrade portal by a user account via a user interface (e.g., via a graphical user interface (GUI)). The OS upgrade portal can display a list of devices. For example, each device can have an associated device type.

At operation 404, processing logic determines whether the user account has been authenticated. If not, the user account cannot proceed to the next steps.

If the user account has been authenticated, then processing logic at operation 406 can receive a selection of a device of a computing environment. At operation 408, processing logic determines whether to initiate an OS upgrade for the device. Determining whether to initiate the OS upgrade for the device can include determining whether an OS upgrade status of the device indicates that the OS of the device should be upgraded. For example, determining whether the upgrade OS status of the device indicates that the OS of the device should be upgraded can include determining whether an upgrade flag for the device is set, as described above with reference to FIG. 1. If processing logic determines not to initiate the OS upgrade for the device, this means that an OS of the device need not be upgraded and the process for the device selected at operation 406 ends. Otherwise, processing logic can select an upgraded OS and a customized set of processes for the device at operation 410. The upgraded OS can be an approved OS compatible with the device, which can be selected from an approved OS list for the device.

At operation 412, processing logic can cause the upgraded OS selected at operation 410 to be staged to obtain a staged OS. At operation 414, processing logic can initiate a precheck process using the staged OS to determine whether to continue with the OS upgrade for the device. At operation 416, processing logic can determine whether the staged OS has passed the precheck process.

If the staged OS has failed the precheck process, this means that the OS upgrade should not continue, and the process can terminate. Alternatively, the process can revert back to operation 414 to initiate another precheck.

Passing the precheck means that the OS upgrade can continue. In some implementations, at operation 418, processing logic initiates monitoring for approval for the OS upgrade and, at operation 420, processing logic determines whether the approval for the OS upgrade has been received. For example, approval for the OS upgrade can be received from a system administrator of the computing environment. If approval for the OS upgrade has not been received, then the process reverts back to operation 418 to continue waiting for approval. In some implementations, the process can terminate if approval is not received within a threshold amount of time.

If approval for the OS upgrade has been received, then processing logic can cause the device to be loaded with the upgraded OS at operation 422. In some implementations, processing logic can cause the device to be loaded with the upgraded OS in response to passing the precheck at operation 418 (e.g., without having to monitor for approval for the OS upgrade at operation 418 and/or determine whether the approval for the OS upgrade has been received at operation 420).

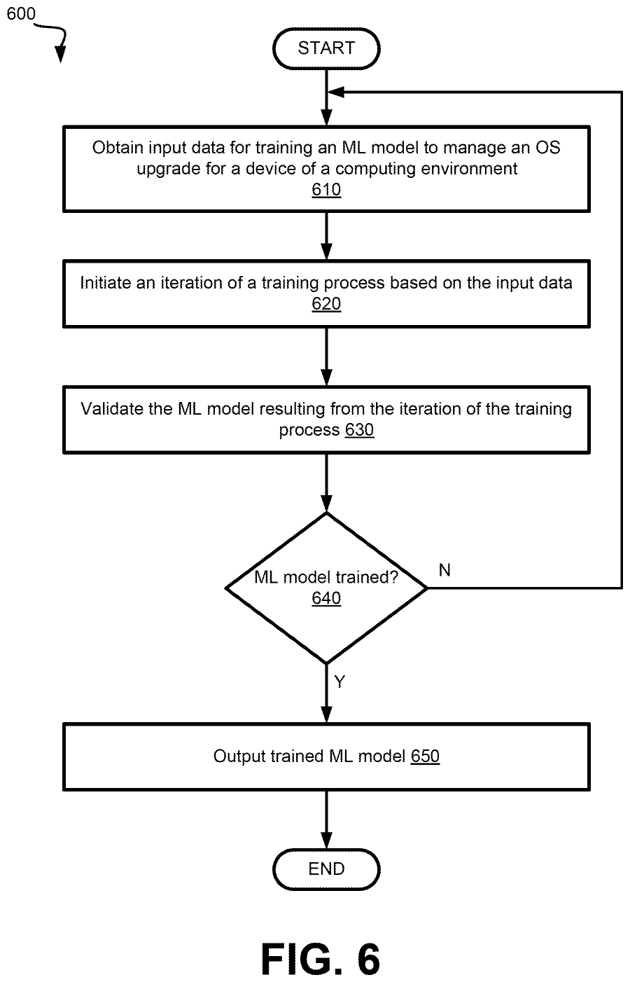

At operation 424, processing logic initiates a post-check process to determine whether to finalize the OS upgrade for the device. If the post-check process indicates that upgrade of the OS can be finalized for the device, then processing logic can finalize the OS upgrade for the device at operation 426. For example, finalizing the OS upgrade can include updating an upgrade status of the device (e.g., updating the upgrade flag). A similar process can be repeated for each device of the computing environment to manage respective OS upgrades. Further details regarding operations 402-426 are described above with reference to FIGS. 1-3 and will now be described below with reference to FIGS. 5-6.

FIG. 5 is a flow diagram of an example method 500 to manage an OS upgrade for at least one device of a computing environment, in accordance with some implementations of the present disclosure. For example, method 500 can correspond to operation 230 of FIG. 2. Method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 500 is performed by one or more components of computing environment 100 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 510, processing logic monitors a computing environment to obtain information related to an upgrade of OS of at a device of the computing environment and, at operation 520, stores the information in a central database. In some implementations, the information includes a set of OS parameters. The information related to the upgrade of the OS of the device can include, for example, system resource utilization of the device pre-OS upgrade and/or post-OS upgrade (e.g., processing resource utilization, memory resource utilization, network resource utilization), change in system resource utilization on a particular time of the day or week or month, frequency of system log generation, number of free processing unit cycles, responsiveness of the device (e.g., how quickly it returns the output of a command, such as a command line interface (CLI) command), etc. For example, the central database can be similar to central database 140 of FIG. 1.

At operation 530, processing logic initiates anomaly detection with respect to the information and, at operation 540, processing logic determines whether an anomaly is detected based on the information. An anomaly can represent a deviation from activity that is normal for the device and/or the computing environment (i.e., abnormal activity). Examples of abnormal activity can include abnormally increased use of system resources (e.g., processing resources, memory resources, network resources), signs of malicious activity, etc. For example, it can be atypical for the type of device to undergo an OS upgrade at a particular frequency based on device history.

For example, a ML model can be used to predict whether the information, as input of the ML model, corresponds to abnormal activity. The ML model can be trained beforehand by, for example, correlating prior information related to the upgrade of the OS of the device to normal activity and/or abnormal activity (e.g., supervised learning). However, the ML model can be trained using any suitable training method (e.g., unsupervised learning, reinforcement learning). Information that can be used to train the ML model can include, for example, system resource utilization of the device pre-OS upgrade and/or post-OS upgrade (e.g., processing resource utilization, memory resource utilization, network resource utilization), change in system resource utilization on a particular time of the day or week or month, frequency of system log generation, number of free processing unit cycles, responsiveness of the device (e.g., how quickly it returns the output of a command, such as CLI command), etc. The ML model can compare the device to other devices running on a different OS and formulate a recommendation to upgrade the device with a particular OS to drive consistency.

If an anomaly is not detected, then the upgrade of the OS can continue, and the process can revert back to operation 510 to continue monitoring the computing environment. If an anomaly is detected, then processing logic at operation 550 can cause the upgrade of the OS to be halted. In some implementations, causing the upgrade to be halted includes causing an upgrade flag of the device to be reset. To do so, processing logic can generate an alert (e.g., message) that the upgrade of the OS should be halted. In some implementations, the upgrade is automatically halted in response to the alert. In some implementations, the upgrade is manually halted in response to the alert (e.g., by a system administrator). The detection of the anomaly can be used as feedback to retrain the ML model to perform anomaly detection during future upgrades of the OS of the device. Further details regarding operations 510-550 are described above with reference to FIGS. 1-4 and will now be described below with reference to FIG. 6.

FIG. 6 is a flow diagram of an example method 600 to train an ML model used to perform dynamic OS lifecycle management, in accordance with some implementations of the present disclosure. Method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 600 is performed by one or more components of computing environment 100 of FIG. 1, such as OS upgrade management system 130. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 610, processing logic obtains input data for training an ML model to manage an OS upgrade for a device of a computing environment. At operation 620, processing logic initiates an iteration of a training process based on the input data. In at least one embodiment, a ML model may be implemented as a deep learning neural network having multiple levels of linear and non-linear operations. In at least one embodiment, a ML model may include multiple neurons that receive inputs from other neurons and/or from an external source and may produce an output by applying an activation function to the sum of weighted inputs and a bias value. In at least one embodiment, a ML model may include multiple neurons arranged in layers, including an input layer, one or more hidden layers, and/or an output layer. A ML model may include convolutional neural layers, fully-connected neural networks, recurrent neural layers, neural networks with memory layers/subnetworks, transformers, conformers, and/or other neural networks.

During the training process, initial parameters (edge weights and biases) of DSTM 120 may be assigned some starting (e.g., random) values. For every training input, the ML model can generate a training output. Training outputs can be compared to target outputs to determine respective errors (e.g., the difference between a training output to the target output). Errors may be quantified using one or more suitable loss functions and backpropagated through the ML model. Various parameters (e.g., weights, biases and hyperparameters) of the ML model may be adjusted to make the training outputs closer to the respective target outputs. This adjustment may be repeated until the output error for a given training input satisfies a predetermined condition (e.g., falls below a predetermined value) or converges to an acceptable level of accuracy. Subsequently, a different training input may be selected, a new output generated, and/or a new series of adjustments implemented, until the respective neural networks are trained to a target degree of accuracy. In some implementations, training of the ML model may be supervised (e.g., using labeled or annotated data), unsupervised, and/or semi-supervised.

At operation 630, processing logic validates the ML resulting from the iteration of the training process. For example, validating the result can include obtaining validation data for validating the result, and inputting the validation data into the ML model to generate an output. At operation 640, processing logic determines whether the ML model is trained based on the validation. If not, then the process can revert back to operation 610 to obtain input data for performing another iteration of the training process. Otherwise, a trained ML model can be output at operation 650.

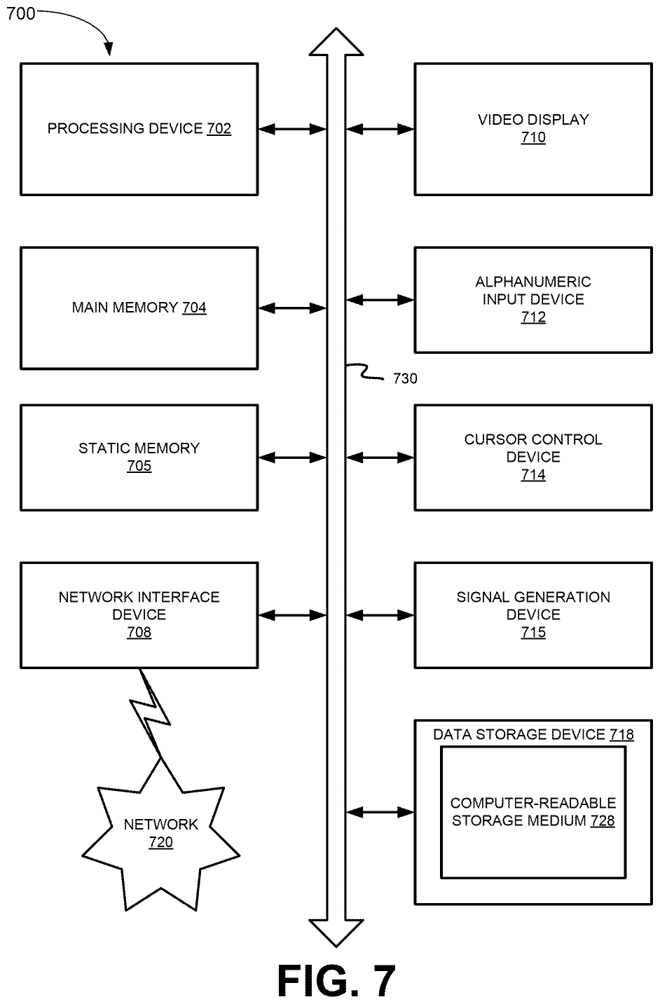

FIG. 7 illustrates a diagrammatic representation of a computer system 700, which may be employed for implementing the methods described herein. The computer system 700 may be connected to other computing devices in a LAN, an intranet, an extranet, and/or the Internet. The computer system 700 may operate in the capacity of a server machine in a client-server network environment. The computer system 700 may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computer system” shall also be taken to include any collection of computing devices that individually or jointly execute a set (or multiple sets) of instructions to perform the methods discussed herein. In illustrative examples, the computer system 700 may represent one or more servers of a distributed computer system implementing one or more of the above-described methods 200-600.

The example computer system 700 may include a processing device 702, a main memory 704 (e.g., synchronous dynamic random access memory (DRAM), read-only memory (ROM)), and a static memory 705 (e.g., flash memory and a data storage device 718), which may communicate with each other via a bus 730.

The processing device 702 may be provided by one or more general-purpose processing devices such as a microprocessor, central processing unit, or the like. In an illustrative example, the processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also comprise one or more special-purpose processing devices such as an application specific integrated circuit (ASIC), a field programmable gate array (FPGA), a digital signal processor (DSP), a network processor, or the like. The processing device 702 may be configured to execute the methods of enabling dynamic OS lifecycle management, in accordance with one or more aspects of the present disclosure.

The computer system 700 may further include a network interface device 708, which may communicate with a network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and/or an acoustic signal generation device 715 (e.g., a speaker). In one embodiment, video display unit 710, alphanumeric input device 712, and cursor control device 714 may be combined into a single component or device (e.g., an LCD touch screen).

The data storage device 718 may include a computer-readable storage medium 728 on which may be stored one or more sets of instructions (e.g., instructions of the methods of automated review of communications, in accordance with one or more aspects of the present disclosure) implementing any one or more of the methods or functions described herein. The instructions may also reside, completely or at least partially, within main memory 704 and/or within processing device 702 during execution thereof by computer system 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” shall be taken to include a single medium or multiple media (e.g., a centralized or distributed database and/or associated caches and servers) that store one or more sets of instructions. The term “computer-readable storage medium” shall also be taken to include any medium that is capable of storing, encoding or carrying a set of instructions for execution by the machine and that causes the machine to perform the methods described herein. The term “computer-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
obtaining, by at least one processing device, input data comprising a set of parameters associated with a computing environment;
determining, by the at least one processing device using a machine learning (ML) model based on the input data, whether a device of the computing environment is due for an operating system (OS) upgrade; and
in response to determining that the device is due for the OS upgrade, initiating, by the at least one processing device, the OS upgrade for the device.

2. The method of claim 1, wherein determining whether the device is due for the OS upgrade further comprises determining whether an upgrade flag for the device is set.

3. The method of claim 1, further comprising managing, by the at least one processing device using the ML model based on the input data, the OS upgrade for the device.

4. The method of claim 3, wherein managing the OS upgrade for the device further comprises:
selecting an approved OS for the device;
performing a staging of the approved OS to obtain a staged OS;
determining, based on the set of parameters, whether to continue the OS upgrade with the staged OS; and
in response to determining to continue the OS upgrade, completing the OS upgrade.

5. The method of claim 4, wherein determining whether to continue the OS upgrade further comprises executing a precheck process based on the staged OS.

6. The method of claim 4, wherein completing the OS upgrade further comprises:
reloading the device with the staged OS; and
executing a post-check process to determine whether an issue with the OS upgrade exists.

7. The method of claim 1, wherein managing the OS upgrade for the device further comprises using the ML model to make a prediction associated with resource consumption within the computing environment.

8. A system comprising:
a memory; and
a processing device, operatively coupled to the memory, to perform operations comprising:
obtaining input data comprising a set of parameters associated with a computing environment;
determining, using a machine learning (ML) model based on the input data, whether a device of the computing environment is due for an operating system (OS) upgrade; and
in response to determining that the device is due for the OS upgrade, initiating the OS upgrade for the device.

9. The system of claim 8, wherein determining whether the device is due for the OS upgrade further comprises determining whether an upgrade flag for the device is set.

10. The system of claim 8, wherein the operations further comprise managing, using the ML model based on the input data, the OS upgrade for the device

11. The system of claim 10, wherein managing the OS upgrade for the device further comprises:
selecting an approved OS for the device;
performing a staging of the approved OS to obtain a staged OS;
determining, based on the set of parameters, whether to continue the OS upgrade with the staged OS; and
in response to determining to continue the OS upgrade, completing the OS upgrade.

12. The system of claim 11, wherein determining whether to continue the OS upgrade further comprises executing a precheck process based on the staged OS.

13. The system of claim 11, wherein completing the OS upgrade further comprises:
reloading the device with the staged OS; and
executing a post-check process to determine whether an issue with the OS upgrade exists.

14. The system of claim 10, wherein managing the OS upgrade for the device further comprises using the ML model to make a prediction associated with resource consumption within the computing environment.

15. A method comprising:
obtaining, by a processing device, input data for training a ML model to manage an operating system (OS) upgrade for a device of a computing environment, wherein the input data comprises a set of training parameters; and
training, by the processing device based on the input data, the ML model to manage the OS upgrade.

16. The method of claim 15, wherein training the ML model to manage the OS upgrade further comprises training the ML model to make a prediction associated with resource consumption with the computing environment.

17. The method of claim 15, wherein training the ML model to manage the OS upgrade further comprises training the ML model to determine whether to continue the OS upgrade.

18. The method of claim 17, wherein training the ML model to manage the OS upgrade further comprises training the ML model to cause the OS upgrade to be halted in response to determining to discontinue the OS upgrade.

19. The method of claim 15, wherein training the ML model to manage the OS upgrade further comprises training the ML model to determine whether an issue with the OS upgrade exists.

20. The method of claim 19, wherein training the ML model to manage the OS upgrade further comprises training the ML model to cause the OS upgrade to be halted in response to determining to that an issue with the OS upgrade exists.
